(19) United States
(12) Patent Application Publication
(10) Pub. No.: US 2016/0341406 A1
(43) Pub. Date: Nov. 24, 2016

(54) Adjustable Lumenaire

(71) Applicant: Energy Savings Technology, LLC, Milpitas, CA (US)

(72) Inventor: Manuel Hoog, Saratoga, CA (US)

(21) Appl. No.: 14/719,168

(22) Filed: May 21, 2015

(51) Int. Cl. F21V 21/14; F21V 23/00; F21V 23/02; F21V 13/04; F21K 99/00; F21V 21/02; F21V 29/70

(52) U.S. Cl. CPC F21V 21/14; F21V 21/02; F21V 23/001; F21V 29/70; F21V 13/04; F21K 9/56; F21V 23/02; F21Y 2101/02

(57) ABSTRACT

A luminaire comprises a cylindrical base element comprising a base end and an opposing first interface end, a first rotary joint coupled to the cylindrical base element, a cylindrical illuminator element comprising a second interface end and an opposing emission end, and a second rotary joint coupled to the cylindrical illuminator element and the cylindrical base element. The cylindrical illuminator element includes comprises a light source configured to generate a light beam having a direction that is determined according to a rotational position of the cylindrical base element about a base rotation axis and a rotational position of the cylindrical illuminator element about a pivot rotation axis.

### FIELD OF THE INVENTION

The present invention relates generally to lighting systems, and more particularly to an adjustable luminaire.

### BACKGROUND

Conventional ceiling-mounted luminaires provide illumination in many common lighting applications. A typical luminaire generates a directional light beam that needs to be directionally adjusted upon installation. For certain applications, the luminaire needs to be installed among other systems that may constrain available space for the luminaire. However, conventional luminaires that provide directional adjustment typically also require a relatively large wiring enclosure above the ceiling, precluding such luminaires from applications with constrained installation space. Other luminaire designs may satisfy installation space requirements but fail to provide adequate optical path efficiency for certain applications. Thus there is a need for addressing these issues and/or other issues associated with the prior art.

### SUMMARY

A luminaire is disclosed herein. In one embodiment, the luminaire includes a cylindrical base element comprising a base end and an opposing first interface end, a first rotary joint coupled to the cylindrical base element, a cylindrical illuminator element comprising a second interface end and an opposing emission end, and a second rotary joint coupled to the cylindrical illuminator element and the cylindrical base element. The base end is substantially parallel to a base plane, and the first interface end is substantially parallel to a cut plane inclined at an oblique cut angle relative to the base plane. The first rotary joint is configured to enable the cylindrical base element to rotate about a base rotation axis, wherein the base rotation axis is normal to the base plane. The second interface end is substantially parallel to the cut plane. The second rotary joint is configured to enable the cylindrical illuminator element to pivot about a pivot rotation axis, wherein the pivot rotation axis is normal to the cut plane. The cylindrical illuminator element further comprises a light source configured to generate a light beam for transmission through the emission end, wherein a direction for the light beam is determined according to a rotational position of the cylindrical base element about the base rotation axis and a rotational position of the cylindrical illuminator element about the pivot rotation axis.

### BRIEF DESCRIPTION OF DRAWINGS

FIG. 1A illustrates a luminaire configured to aim a light beam according to two rotational positions, in accordance with one embodiment of the present invention.

FIG. 1B illustrates a luminaire in a pivoted position, in accordance with one embodiment.

FIG. 2A illustrates a luminaire configured to aim a light beam directly downward, in accordance with one embodiment.

FIG. 2B illustrates a cross-section of a luminaire configured to aim a light beam directly downward, in accordance with one embodiment.

FIG. 2C illustrates a luminaire configured to aim a light beam at a non-zero elevation angle, in accordance with one embodiment.

FIG. 2D illustrates a cross-section of a luminaire configured to aim a light beam at a non-zero elevation angle, in accordance with one embodiment.

FIG. 2E illustrates a luminaire configured to be coupled to a mounting medium, in accordance with one embodiment.

FIG. 2F illustrates a luminaire coupled to a mounting medium, in accordance with one embodiment.

FIG. 3A illustrates a luminaire configured to aim a light beam directly downward, in accordance with one embodiment.

FIG. 3B illustrates a side view of a luminaire configured to aim a light beam at an elevation angle, in accordance with one embodiment.

FIG. 3C illustrates an exploded view of components comprising an exemplary luminaire, in accordance with one embodiment.

FIG. 4A illustrates a side view of a pivot stem coupled to a pivot stem mate, in accordance with one embodiment.

FIG. 4B illustrates a front view of a pivot stem coupled to a pivot stem mate, in accordance with one embodiment.

FIG. 4C illustrates a side view of a pivot stem coupled to a pivot stem mate in a pivoted position, in accordance with one embodiment.

FIG. 4D illustrates a side view cross-section of a pivot stem coupled to a pivot stem mate in a pivoted position, in accordance with one embodiment.

FIG. 4E illustrates a pivot stem coupled to a pivot stem mate, in accordance with one embodiment.

FIG. 4F illustrates a pivot stem mate, in accordance with one embodiment.

FIG. 4G illustrates a luminaire with a cut angle that is equal to an illuminator cut angle, in accordance with one embodiment.

FIG. 4H illustrates a luminaire with a cut angle that is larger than an illuminator cut angle, in accordance with one embodiment.

FIG. 5A illustrates a cut plane associated with an elliptical cross-section, in accordance with one embodiment.

FIG. 5B illustrates a perpendicular view of a cut plane associated with an elliptical cross-section, in accordance with one embodiment.

FIG. 6A illustrates a luminaire that includes a secondary housing, in accordance with one embodiment.

FIG. 6B illustrates a luminaire comprising a pivoted illuminator unit within a secondary housing, in accordance with one embodiment.

### DETAILED DESCRIPTION

Embodiments of the present invention set forth a luminaire apparatus configured to provide two rotational degrees of movement for adjusting the direction of a light beam generated by a light source within the luminaire. The luminaire may comprise a base element coupled to an illuminator element, which is configured to generate the light beam. The base element may be rotationally coupled to a mounting surface, such as a ceiling. In one embodiment, a first of the two rotational degrees of movement is provided about a base rotation axis. The base rotation axis may be normal to a base plane, which may be parallel with the mounting surface. The base rotation axis may be coincident with a centerline for the overall luminaire apparatus. As the base element rotates about the base rotation axis, the illuminator element and consequently the direction of the light beam rotate with the base element.

The illuminator element may be rotationally coupled to the base element and configured to rotate about a pivot rotation axis that is normal to a cut plane associated with a rotational interface between the base element and the illuminator element. In one embodiment, a second of the two rotational degrees of movement is provided about the pivot rotation axis. The cut plane should be inclined according to an oblique cut angle relative to the base plane. As the illuminator element rotates about the pivot rotation axis, the light beam is directed along a corresponding elevation angle measured relative to the base rotation axis. The elevation angle should range between a minimum elevation angle and a maximum elevation angle. In one embodiment, the minimum elevation angle is nominally zero and the maximum elevation angle is nominally twice the oblique cut angle as the illuminator element rotates completely about the pivot rotation axis. Furthermore, in one embodiment the base element may rotate completely about the base rotation axis.

In combination, the first rotational degree of movement about the base rotation axis and the second rotational degree of movement about the pivot rotation axis enable the light beam to be directed along any direction within a spherical section, limited by the oblique cut angle. For example, in one embodiment the oblique cut angle is forty-five degrees and the elevation angle may vary between zero (parallel with the base rotation axis) and ninety degrees (perpendicular to the base rotation axis). In combination with a base rotation of zero through three-hundred sixty degrees, the light beam may be directed to any point within a complete hemisphere projected about the luminaire. In certain embodiments, the oblique cut angle may be less than forty-five degrees. For example, in one embodiment the oblique cut angle may be specified as twenty-two and one half degrees and the elevation angle may range from approximately zero to approximately forty-five degrees. In another embodiment, the oblique cut angle is thirty degrees and the elevation angle may range from approximately zero to approximately sixty degrees.

In one embodiment, the illuminator element includes the light source (e.g., one or more light-emitting diodes), a reflector for directing light from the light source to the lens, and a lens for collecting and directing light to form the light beam. The light source, reflector, and lens may be fabricated in a fixed geometric relationship to provide a substantially fixed optical path regardless of where the light beam is directed. The fixed optical path may be advantageously optimized for high transmission efficiency relative to variable path designs found in prior art luminaire devices. Further details describing embodiments of the present invention are provided below.

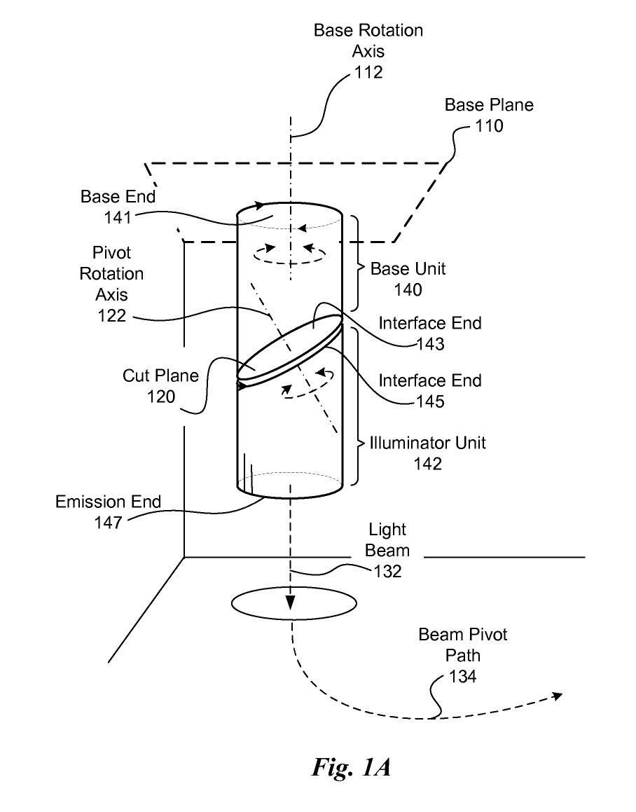

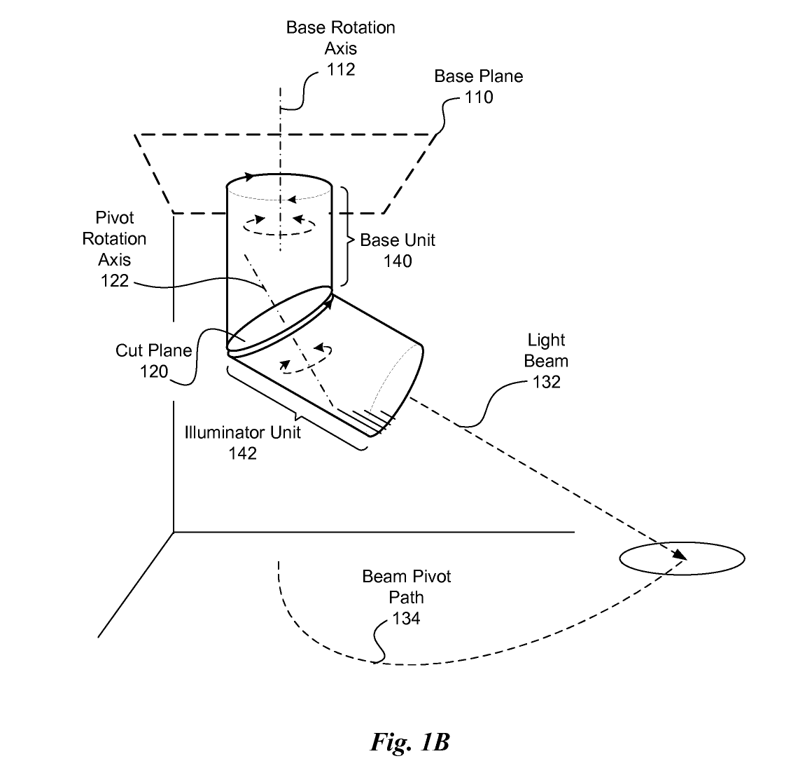

FIG. 1A illustrates a luminaire configured to aim a light beam 132 according to two rotational positions, in accordance with one embodiment of the present invention. As shown, the luminaire comprises a base unit 140 corresponding to the base element described previously and an illuminator unit 142 corresponding to the illuminator element described previously.

In one embodiment, base unit 140 is fabricated to form a cylindrical volume. Furthermore, base unit 140 comprises a base end 141 and an opposing interface end 143. Base end 141 is fabricated to be substantially flat and perpendicular to a base rotation axis 112. In one embodiment, base end 141 is substantially parallel with a base plane 110. Interface end 143 is fabricated to include an interface surface that is substantially parallel with a cut plane 120. In one embodiment, cut plane 120 is inclined at an oblique cut angle relative to base plane 110.

Base unit 140 is rotationally coupled, such as through a first rotary joint (not shown), to a mounting medium on base end 141, the mounting medium being substantially parallel to base plane 110. Base unit 140 may rotate about base rotation axis 112 as enabled by the first rotary joint. In one embodiment, base rotation axis 112 may be normal to base plane 110.

Illuminator unit 142 comprises an interface end 145 and an opposing emission end 147. Interface end 145 is fabricated to include an interface surface that is substantially parallel with cut plane 120. Emission end 147 is open or optically transparent, such as through a lens, to provide an optical path for light beam 132. As shown, illuminator unit 142 may be rotationally coupled, such as through a second rotary joint (not shown), to base unit 140. Illuminator unit 142 may rotate about a pivot rotation axis 122 as enabled by the second rotary joint.

In one embodiment, base unit 140 and illuminator unit 142 each comprise a cylindrical volume having an elliptical cross-section along a plane that is parallel to base plane 110 when light beam 132 is pointed directly down, as shown. In such an embodiment, the elliptical cross-section includes a major axis (also referred to as major radius) and a minor axis (minor radius), the major axis having a longer length than the minor axis. In certain embodiments, each cylindrical volume has a circular cross-section rather than an elliptical cross-section.

As shown, illuminator unit 142 is positioned to direct light beam 132 substantially straight down, at an elevation angle of approximately zero degrees, as measured relative to base rotation axis 112. As illuminator unit 142 is pivoted about pivot rotation axis 122, light beam 132 follows a beam pivot path 134. Note that pivoting illuminator unit 142 about pivot rotation axis 122 effectively also rotates the direction of light beam 132 about the base rotation axis 112. Effective rotation about base rotation axis 112 due to pivoting illuminator unit 142 around pivot rotation axis 122 may be countered by an appropriate corresponding rotation of base unit 140 about base rotation axis 112. A combination of a given rotation position of base unit 140 and a given pivot position of illuminator unit 142 enables light beam 132 to be directed within at least a portion of a spherical section, as constrained primarily by a range for the elevation angle defined by at least the oblique cut angle that defines the inclination of cut plane 120.

FIG. 1B illustrates the luminaire of FIG. 1A in a pivoted position, in accordance with one embodiment. As shown, illuminator unit 142 is in a pivoted position about pivot rotation axis 122, thereby directing light beam 132 to a corresponding position along beam pivot path 134. Furthermore, light beam 132 may be separately rotated about base rotation axis 112 by rotating base unit 140 about base rotation axis 112.

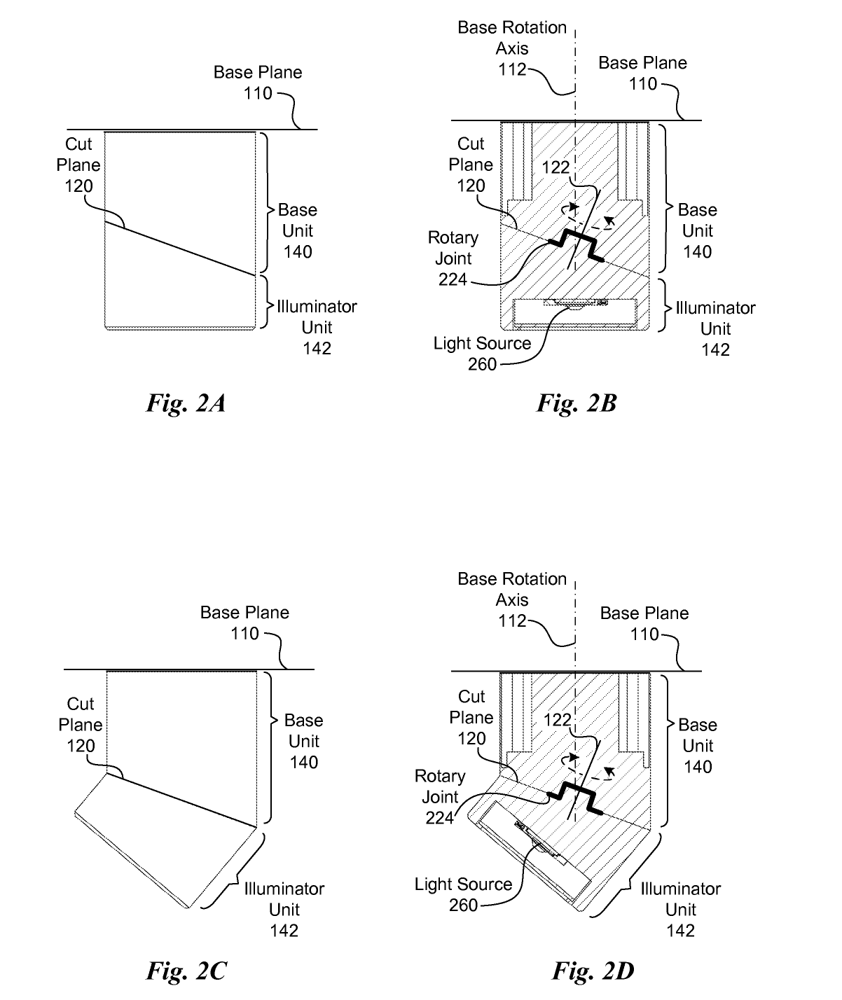

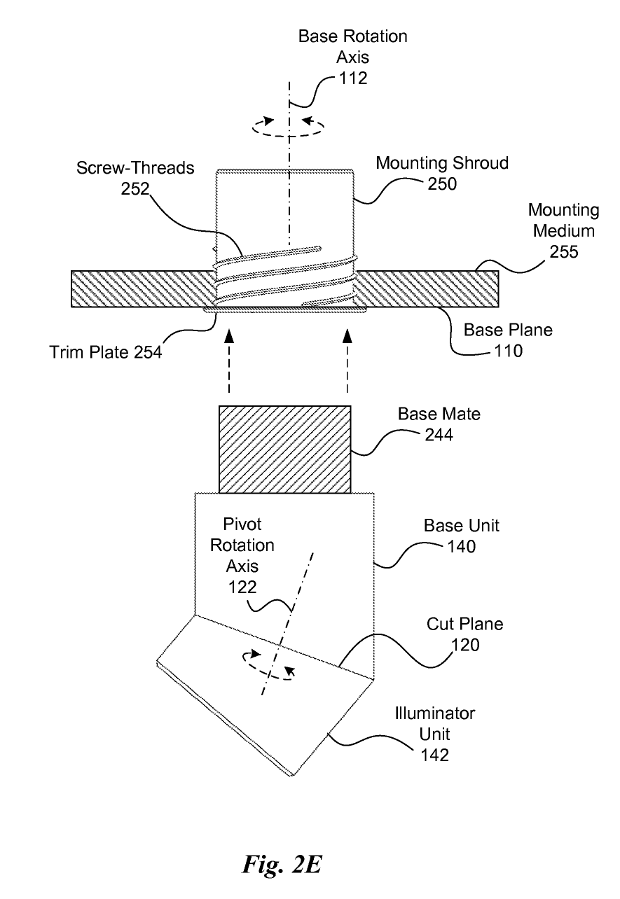

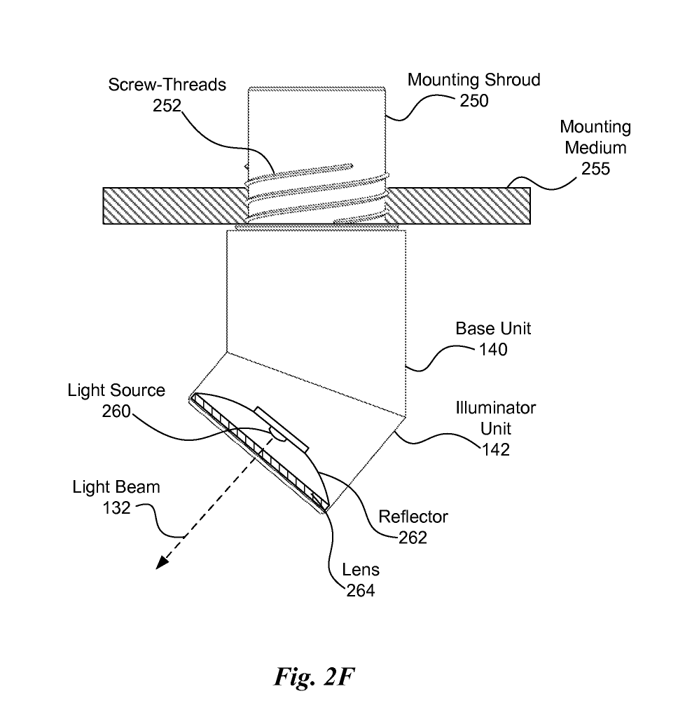

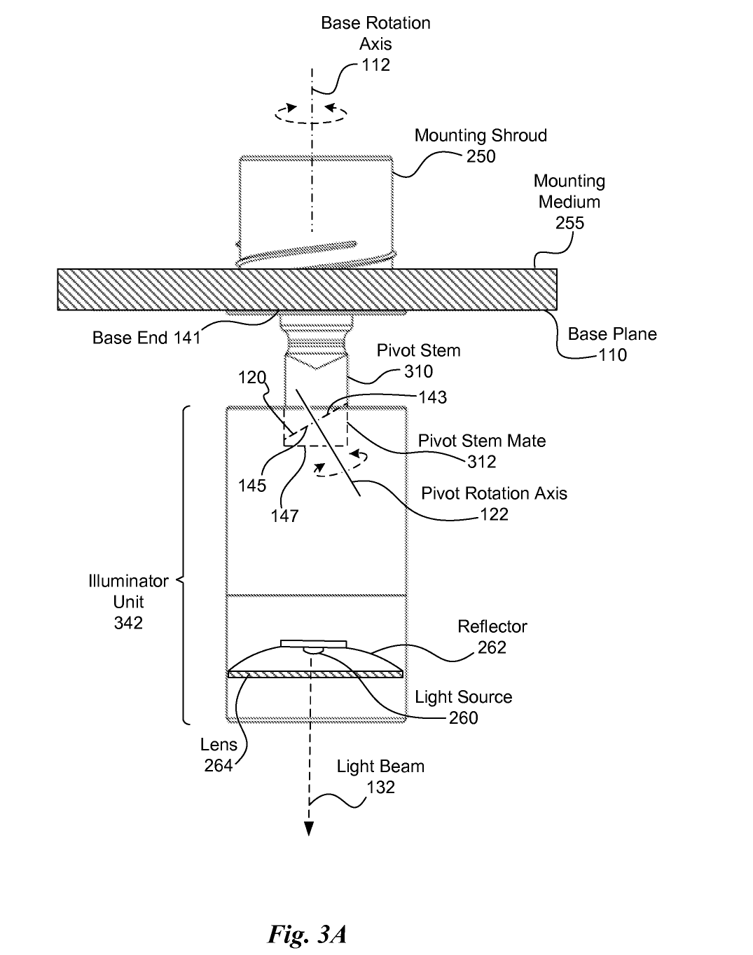

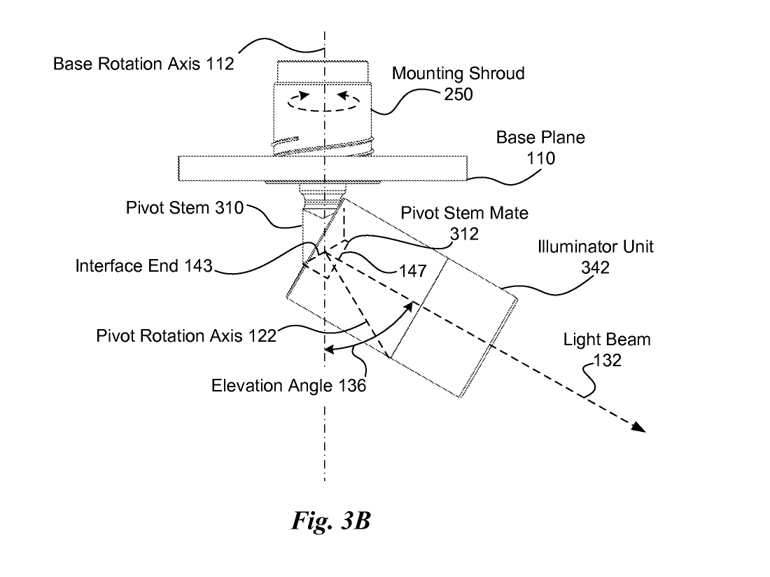

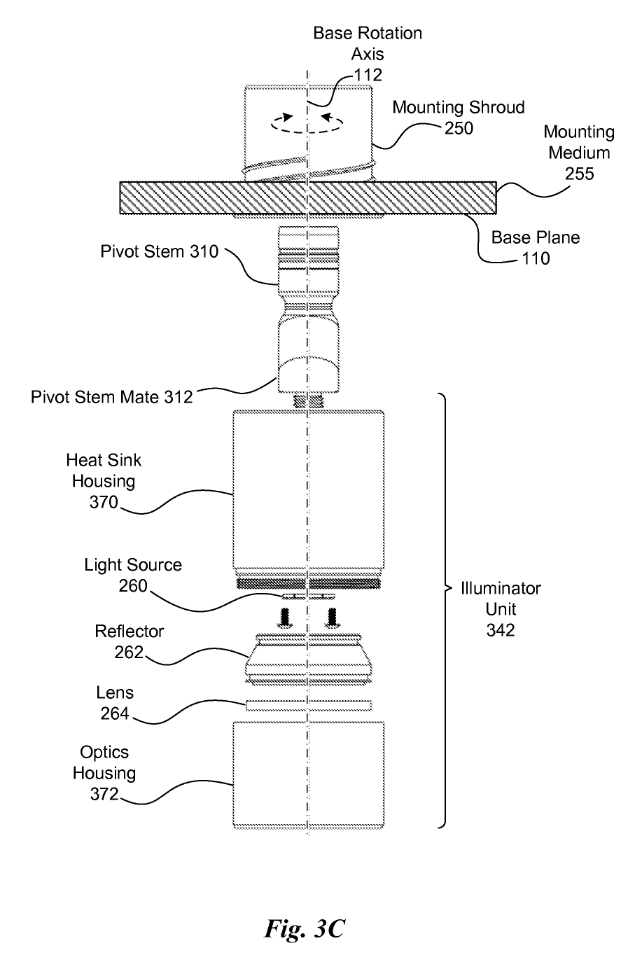

FIG. 2A illustrates an exemplary luminaire configured to aim a light beam directly downward, in accordance with one embodiment. FIG. 2B illustrates a cross-section of the luminaire of FIG. 2A, in accordance with one embodiment. As shown, pivot rotation axis 122 is perpendicular (normal) to cut plane 120. Furthermore, a rotary joint 224 rotationally couples base unit 140 to illuminator unit 142, enabling illuminator unit 142 to rotate about pivot rotation axis 122 relative to base unit 140. A light source 260 is disposed within illuminator unit 142 and configured to generate a light beam, such as light beam 132 of FIG. 1A. FIG. 2C illustrates the luminaire of FIG. 2A, configured to aim a light beam (not shown) at a non-zero elevation angle, in accordance with one embodiment. FIG. 2D illustrates a cross-section of the luminaire of FIG. 2A, configured to aim a light beam (not shown) at a non-zero elevation angle, in accordance with one embodiment. As described previously, the elevation angle may be measured relative to base rotation axis 112. Elevation angle is illustrated below in FIG. 3B.

FIG. 2E illustrates a luminaire configured to be coupled to a mounting medium 255, in accordance with one embodiment. Mounting medium 255 may comprise a ceiling panel, a wall panel, or any other structural or cosmetic building element. Mounting medium 255 may be constructed from wood, sheetrock, concrete, or any other suitable building material. A mounting shroud 250 is fabricated to include screw-threads 252, configured to be screwed into a pre-cut hole within mounting medium 255. Screw-threads 252 may comprise any technically feasible geometry. Mounting shroud 250 may further include a trim plate 254 configured to cover potentially rough edges associated with the pre-cut hole, thereby providing a smooth and potentially more aesthetically pleasing visible interface between mounting shroud 250 and mounting medium 255.

In one embodiment, a base mate 244 is coupled to base unit 140. Base mate 244 may be further coupled to mounting shroud 250. Any technically feasible mechanism may be implemented to couple base mate 244 to mounting shroud 250. In one embodiment, base mate 244 is permanently coupled to base unit 140 and may be structurally integrated with base unit 140. Furthermore, base mate 244 may be removably coupled to mounting shroud 250, such as through ball lock or a ball plunger and groove fastener.

FIG. 2F illustrates the luminaire of FIG. 2E coupled to mounting medium 255, in accordance with one embodiment. As shown, illuminator unit 142 comprises light source 260 and a reflector 262. Illuminator 142 may further comprise a lens 264. In such a configuration, some light generated by light source 260 may be directly transmitted to lens 264, while some light is reflected by reflector 262 and guided by lens 264 to provide a light beam 132 having specified properties, such as a particular beam angle. Lens 264 may be implemented as a Fresnel lens, a spherical section lens, a flat lens, or any other technically feasible type of lens. In certain embodiments, Lens 264 may include remote phosphor, such as a coating or a solid volume of remote phosphor.

In one embodiment, light source 260 comprises a light-emitting diode (LED) module. The LED module may include one or more individual LED chips. The LED module may include a set of LED chips, each configured to generate a specific dominant wavelength so that the set of LED chips collectively generates an appropriate spectral profile. Alternatively, the LED module may include a set of blue or ultra-violate (UV) LED chips configured to excite a spectral conversion element comprising a mix of phosphor compounds that convert light energy from the blue/UV LED chips to longer wavelengths, thereby generating an appropriate spectral profile.

In one embodiment, reflector 262 includes a reflective surface, such as polished metal, vapor-deposited metal, a reflective coating, or any combination thereof. In one embodiment, reflector 262 is fabricated from a synthetic optical polymer, such as polytetrafluoroethylene (PTFE), which may be fabricated to provide a highly reflective surface. Lens 264 may be fabricated from an optically clear material to provide a relatively high-degree of optical transmission. For example, Lens 264 may be fabricated to transmit more than ninety-five percent of visible light energy. In certain embodiment, lens 264 may include optical coating layers to further improve transmission. Alternatively, lens 264 may attenuate transmission of certain wavelengths to impart color on light beam 132. Reflector 262 and lens 264 may be fabricated according to any technically feasible combination of geometries. For example, reflector 262 may be fabricated according to a substantially parabolic geometry, while lens 264 may be fabricated according to a substantially spherical section geometry.

In one embodiment, base unit 140 is coupled to an electrical power source, such as a power source associated with municipal power mains. Electrical power is transmitted from base unit 140 to light source 260 through electrical wires, rotary electrical contacts associated with one or more rotary joints, or any combination thereof.

As shown, mounting shroud 250 occupies a fixed volume above mounting medium 255, independent of the direction of light beam 132. Consequently, electrical connections may be made routed through mounting shroud 250 with minimal need for additional exclusion volume associated with typical prior art directionally adjustable luminaires.

FIG. 3A illustrates a luminaire configured to aim a light beam 132 directly downward, in accordance with one embodiment. As shown, the luminaire comprises a pivot stem 310, corresponding to the base element described previously, and an illumination unit 342 corresponding to the illuminator element also described previously. A pivot stem mate 312 is coupled to illuminator unit 342, which is rotationally coupled, such as through a rotary joint, to pivot stem 310. Pivot stem mate 312 is configured to rotate about pivot rotation axis 122 at cut plane 120. Pivot stem 310 and pivot stem mate 312 are described in greater detail below. Pivot stem 310 may be coupled to a base mate, such as base mate 244 of FIG. 2E to facilitate further coupling to mounting shroud 250.

In one embodiment, pivot stem 310 is fabricated to form a cylindrical volume. Furthermore, pivot stem 310 comprises a base end 141 and an opposing interface end 143. Base end 141 is fabricated to be substantially flat and perpendicular to a base rotation axis 112. Pivot stem 310 is rotationally coupled, such as through a first rotary joint (not shown), to a mounting medium on base end 141, the mounting medium being substantially parallel to base plane 110. Interface end 143 is fabricated to include an interface surface that is substantially parallel with cut plane 120.

Pivot stem mate 312 comprises an interface end 145 and an opposing emission end 147. Interface end 145 is fabricated to include an interface surface that is substantially parallel with cut plane 120. Emission end 147 is configured to be coupled to at least one component additional comprising illuminator unit 342.

FIG. 3B illustrates a side view of the luminaire of FIG. 3A configured to aim light beam 132 at an elevation angle 136, in accordance with one embodiment. As shown, elevation angle 136 is measured relative to base rotation axis 112. When elevation angle 136 is equal to zero, light beam 132 is directed straight down and aligned to base rotation axis 112. From this position, illuminator unit 342 may be pivoted about pivot rotation axis 122, causing light beam 132 to follow beam pivot path 134 while elevation angle 136 correspondingly increases.

FIG. 3C illustrates an exploded view of components comprising an exemplary luminaire, such as the luminaire of FIG. 3A, in accordance with one embodiment. In this embodiment, base rotation axis 112 comprises a centerline for components comprising the exemplary luminaire. Pivot stem 310, pivot stem mate 312, a heat sink housing 370, light source 260, reflector 262, lens 264, and an optics housing 372 may be aligned along the centerline upon assembly.

In one embodiment, optics housing 372 is configured to secure lens 264 and reflector 262 into a fixed geometric relationship with respect to light source 260. For example, heat sink housing 370 may include threading on one end and optics housing 372 may include complementary threading in an interfacing end so that optics housing 372 may be screwed on to heat sink housing 370, thereby securing reflector 262 and lens 264 in place.

In one embodiment, light source 260 may be thermally coupled to a heat sink (not shown) within heat sink housing 370. Furthermore, the heat sink may comprise heat dispersal fins fabricated in a radial pattern about the centerline and oriented vertically to facilitate primarily vertically-oriented convection.

In one embodiment, pivot stem 310 and pivot stem mate 312 each comprise a cylindrical volume having an elliptical cross-section along a plane that is parallel to base plane 110 when aligned along the centerline as shown. In such an embodiment, the elliptical cross-section includes a major axis having a larger length than a minor axis. With an appropriate elliptical cross-section for pivot stem 310 and matching elliptical cross-section for pivot stem mate 312, cut plane 120 may substantially conform to a circle. Furthermore, an interface edge between pivot stem 310 and pivot stem mate 312 may be rotationally invariant. In such an embodiment, the interface edge may lack any rotationally-dependent protrusions, which may be aesthetically displeasing and which may detrimentally reduce convection cooling performance. In certain embodiments, the cylindrical volume has a circular cross-section rather than an elliptical cross-section. In such embodiments, cut plane 120 may substantially conform to a non-circular ellipse, and the interface edge may have rotationally-dependent protrusions In certain other embodiments, pivot stem 310 and pivot stem mate 312 may include an elliptical cross-section, while heat sink housing 370 and optics housing 372 may have a different cross-section, such as a circular cross-section. In such embodiments, cut plane 120 may substantially confirm to a circle, and the interface edge may lack any rotationally-dependent protrusions.

In one embodiment, pivot stem 310 is coupled to a cable (not shown) and suspended from a ceiling mount, such as mounting shroud 250. Alternatively, the cable may be coupled to a wall mount, which may comprise mounting shroud 250. In certain embodiments, the wall mount may include a beam, rod, bracket, or other substantially rigid structural member (not shown) disposed at the top end of the cable and oriented between the cable and a proximal wall to enable the cable and luminaire unit 342 to hang freely, without contacting the proximal wall. Pivot stem 310 may be coupled to the cable through the first pivot joint. The cable may be configured to provide electrical connections from the ceiling mount to pivot stem 310 for transmitting electrical energy to pivot stem 310 and ultimately to light source 260. In another embodiment, pivot stem 310 is coupled to a vertical rod assembly (not shown) that is coupled to the ceiling mount or the wall mount, the vertical rod assembly configured to transmit electrical energy to light source 260 through pivot stem 310. Pivot stem 310 may be coupled to the vertical rod through the first pivot joint. In one embodiment, a pair of insulated electrical wires is configured to transmit electrical energy from the ceiling mount to pivot stem 310.

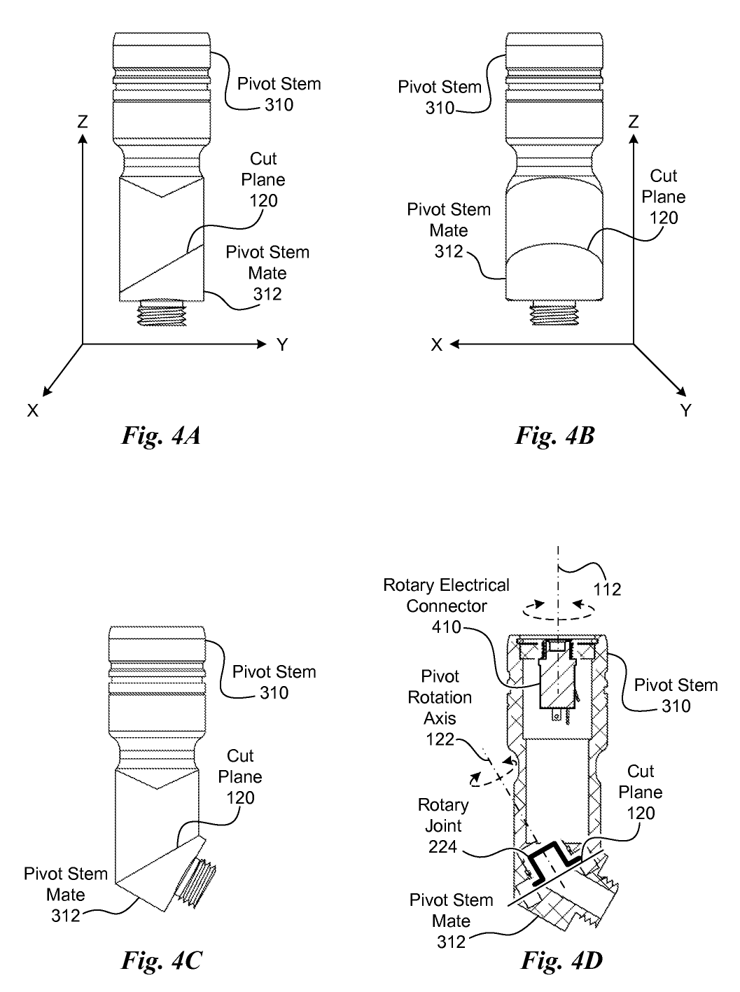

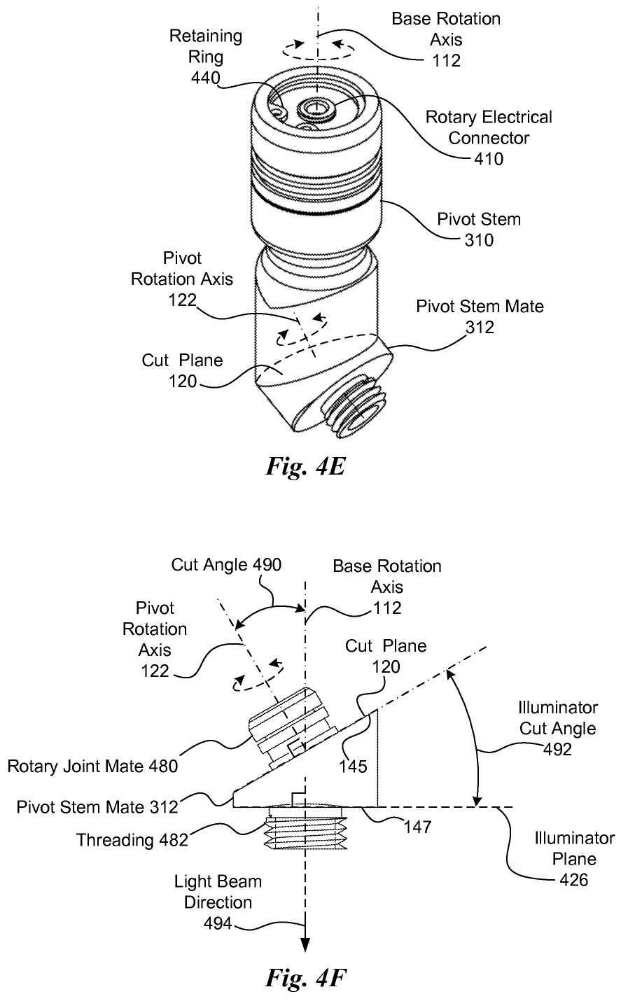

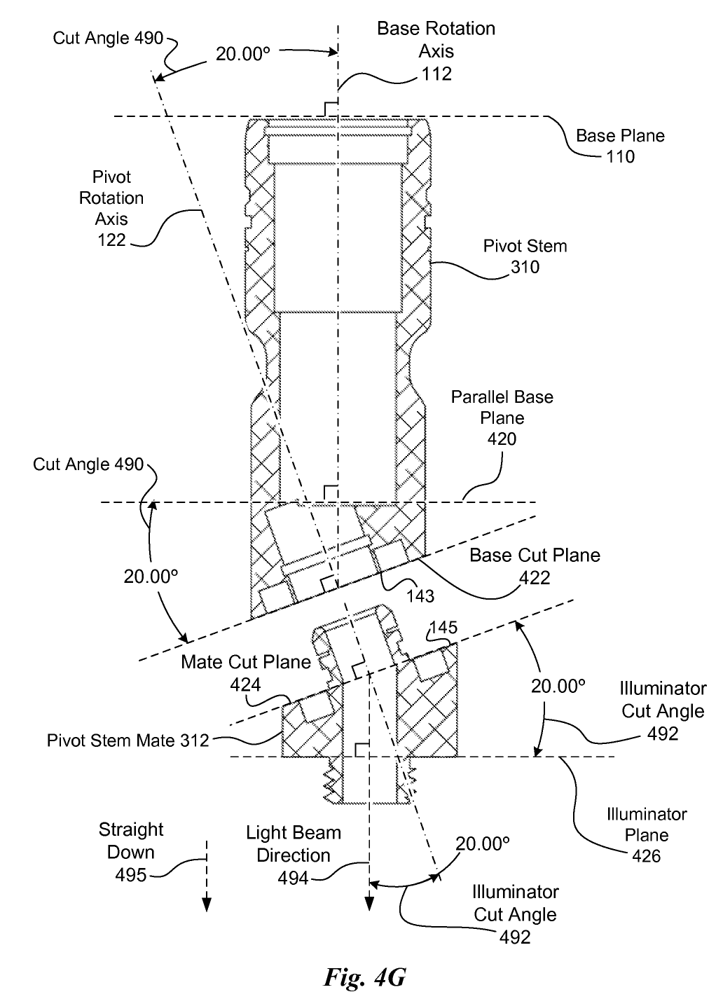

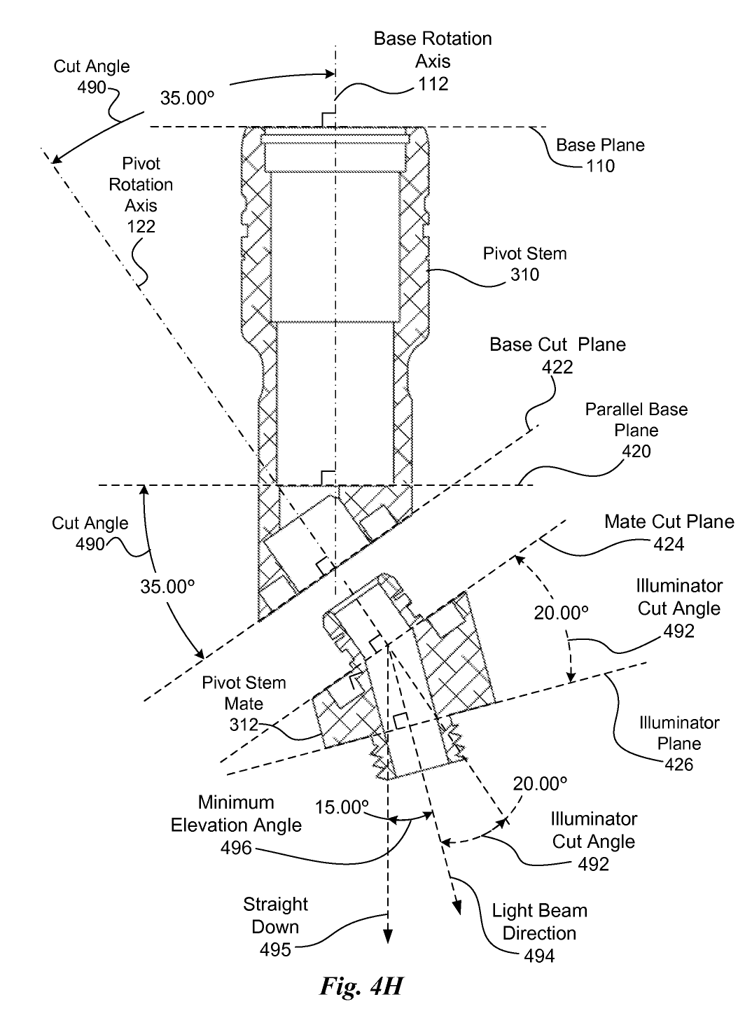

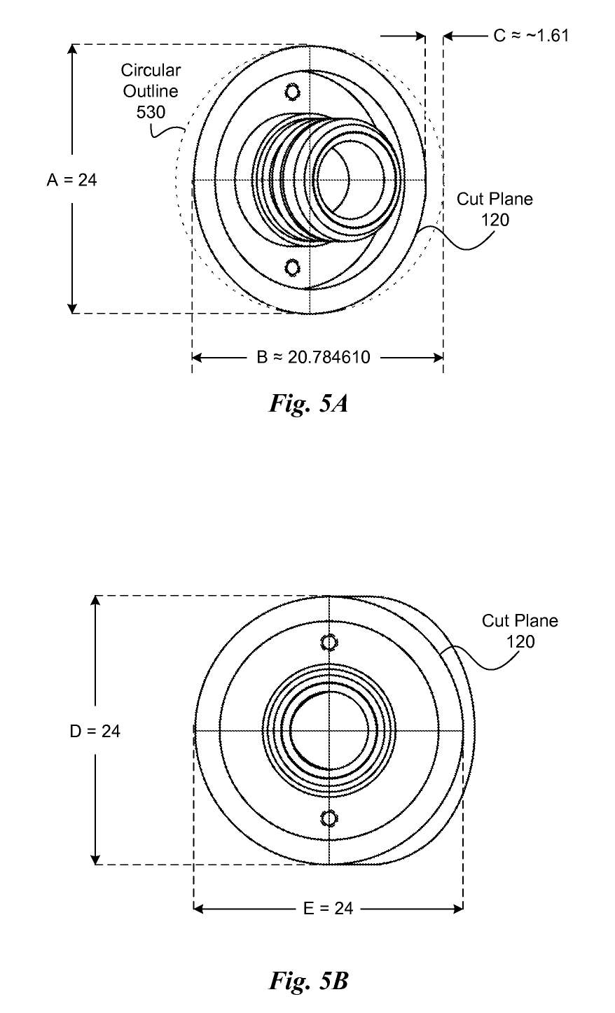

FIG. 4A illustrates a side view of pivot stem 310 coupled to pivot stem mate 312, in accordance with one embodiment. As described previously, pivot stem mate 312 is configured to pivot about pivot rotation axis 122 at cut plane 120. From this side view perspective, cut plane 120 forms a straight line along the interface between pivot stem 310 and pivot stem mate 312. With an appropriate elliptical cross-section, cut plane 120 substantially conforms to a circle, allowing pivot stem 310 and pivot stem mate 312 to meet along a uniform, rotationally invariant interface edge (substantially lacking rotationally variant protrusions).

FIG. 4B illustrates a front view of pivot stem 310 coupled to pivot stem mate 312, in accordance with one embodiment. From this front view perspective, cut plane 120 forms an arc along the interface between pivot stem 310 and pivot stem mate 312. As shown, the arc formed along cut plane 120 may represent a portion of a uniform, rotationally invariant interface edge.

FIG. 4C illustrates a side view of pivot stem 310 coupled to pivot stem mate 312 in a pivoted (rotated) position, in accordance with one embodiment. This pivoted position corresponds to the pivoted position depicted for illuminator unit 342 in FIG. 3B. As shown, no protrusion is formed along cut plane 120. However, if cut plane 120 were an ellipse rather than a circle, a protrusion may be formed along the interface edge in certain rotational configurations.

FIG. 4D illustrates a side view cross-section of pivot stem 310 coupled to pivot stem mate 312 in a pivoted position, in accordance with one embodiment. In certain embodiments, a rotary joint 224 couples pivot stem mate 312 to pivot stem 310, and enables pivot stem mate 312 to rotate about pivot rotation axis 122 with respect to pivot stem 310. Pivot stem 310 may further comprise rotary electrical connector 410, configured to provide an electrical path to transmit electrical energy from electrical conductors within mounting shroud 250 to electrical conductors within pivot stem 310 as pivot stem 310 rotates about base rotation axis 112. Such electrical conductors may comprise electrical wires. Furthermore, rotary joint 224 may be configured to provide a further electrical path to transmit the electrical energy from pivot stem 310 to pivot stem mate 312, thereby completing an electrical path from mounting shroud 250 to illuminator unit 342. The electrical path enables electrical energy to be transmitted from an energy source, such as power mains, to light source 260. The electrical path traverses mechanical structures providing the two rotational degrees of movement. In certain embodiments, energy received from the power mains is converted by a converter system (not shown) to voltage signal levels and/or current signal levels suitable for appropriately controlling light source 260. The converter system may be positioned in any technically feasible location as would be understood by one of skill in the art in light of the teachings disclosed herein.

FIG. 4E illustrates pivot stem 310 coupled to pivot stem mate 312, in accordance with one embodiment. As shown, a retaining ring 440 may be used to secure rotary electrical connector 410 within pivot stem 310. More generally, a retaining ring, such as retaining ring 440, may be used to secure different elements together during assembly.

FIG. 4F illustrates pivot stem mate 312, in accordance with one embodiment. As shown, pivot stem mate 312 may include a rotary joint mate 480, oriented to rotate about pivot rotation axis 122. When rotary joint mate 480 is joined with a complementary cavity structure (not shown) within pivot stem 310, rotary joint 224 of FIG. 2D is formed. Pivot stem mate 312 may also include threading 482, for coupling pivot stem mate 312 to one or more components comprising illuminator unit 342 of FIG. 3C. For example, threading 482 may be coupled to heat sink housing 370 of FIG. 3C. Alternatively, threading 482 may be directly connected to a heat sink element within heat sink housing 370. In one embodiment, pivot stem mate 312, pivot stem 310, or both pivot stem mate 312 and pivot stem 310 include one or more magnets (not shown) disposed along cut plane 120 and configured to provide retention force between pivot stem mate 312 and pivot stem 310.

The oblique cut angle discussed previously is depicted here as a cut angle 490. Consistent with previous descriptions of the oblique cut angle, cut angle 490 represents an angle of incline of cut plane 120 from base plane 110. Base rotation axis 112 may be normal to base plane 110. Consequently, cut angle 490 may be measured as an angle between base rotation axis 112 and pivot rotation axis 122, which may be normal to cut plane 120. An illuminator cut angle 492 may be measured between a plane, such as cut plane 120, which is parallel with interface end 145 and an illuminator plane 426, which is parallel to illuminator end 147. A light beam direction 494 represents a direction for light beam 132. Light beam direction 494 may be normal to illuminator plane 426. In one embodiment, which represents a special case, cut angle 490 and illuminator cut angle 492 are equal, and a resulting elevation angle may range from zero (straight down) to twice that of cut angle 490. For example, in one such embodiment cut angle 490 is thirty degrees and illuminator cut angle 492 is also thirty degrees. In this embodiment, light beam direction 494 follows an elevation angle ranging from a minimum of substantially zero degrees (straight down, parallel to base rotation axis 112) to a maximum of substantially sixty degrees as light source 260 (and therefore pivot stem mate 312) is pivoted about pivot rotation axis 122. In another embodiment, cut angle 490 is thirty degrees and illuminator cut angle 492 is twenty degrees. In such an embodiment, light beam direction 494 follows an elevation angle ranging from a minimum of ten degrees to a maximum of fifty degrees, as light source 260 is pivoted about pivot rotation axis 122. In the above examples, the minimum elevation angle may be determined as a difference between cut angle 490 and illuminator cut angle 492, and the maximum elevation angle may be determined as the sum of cut angle 490 and illuminator cut angle 492.

FIG. 4G illustrates a luminaire with cut angle 490 configured to be equal to illuminator cut angle 492, in accordance with one embodiment. A base cut plane 422 is parallel to interface end 143, and a mate cut plane 424 is parallel to interface end 145. Cut angle 490 may be measured as an angle of incline between cut plane 120 and base plane 110, or more generally, as an angle of incline between base cut plane 422 and parallel base plane 420. Parallel base plane 420 may be parallel to base plane 110. Equivalently, cut angle 490 may be measured as an angle between base rotation axis 112 and pivot rotation axis 122. Illuminator cut angle 492 may be measured as an angle of incline between mate cut plane 424 and illuminator plane 426, described previously in FIG. 4E. In one embodiment, base cut plane 422 and mate cut plane 424 form substantially identical geometries that both conform to cut plane 120. In certain embodiments, mate cut plane 424 may form a geometry having a smaller area than base cut plane 422. In other embodiments, mate cut plane 424 may form a geometry having a larger area than base cut plane 422.

In the special case with cut angle 490 configured to be equal to illuminator cut angle 492, an elevation angle, such as elevation angle 136 of FIG. 3B, may range from zero to twice cut angle 490. At one extreme, pivot stem mate 312 is positioned such that the elevation angle is the sum of cut angle 490 and a negative illuminator cut angle 492, yielding a minimum elevation angle of zero. When the elevation angle is zero, light beam direction 494 is aligned in a straight down direction 495. At another extreme, pivot stem mate 312 is positioned such that the elevation angle is the sum of cut angle 490 and a positive illuminator cut angle 492, yielding a maximum elevation angle.

As shown, both cut angle 490 and illuminator cut angle 492 are equal to twenty degrees. In this configuration, the minimum elevation angle is zero degrees and the maximum elevation angle is forty degrees.

FIG. 4H illustrates a luminaire with cut angle 490 configured to be larger than illuminator cut angle 492, in accordance with one embodiment. As shown, cut angle 490 is substantially equal to thirty-five degrees and illuminator cut angle 492 is substantially equal to twenty degrees. In this configuration, a minimum elevation angle 496 is fifteen degrees, while a maximum elevation angle is fifty-five degrees. With minimum elevation angle 496 equal to fifteen degrees, light beam direction 494 may not be pointed straight down (along straight down direction 495), regardless of rotational position of pivot stem mate 312 about pivot rotation axis 122.

FIG. 5A illustrates a cut plane 120 associated with an elliptical cross-section, in accordance with one embodiment. Cut plane 120 is depicted here from a perspective facing directly at the elliptical cross-section. A circular outline 530 is shown as a bounding outline of the elliptical cross-section. Cut plane 120 may be circular, and the elliptical cross-section may be associated with pivot stem mate 312. Cut plane 120 may also be associated with a cross-section of pivot stem 310, base unit 140, or illuminator unit 342. More generally, cut plane 120 may be associated with a cross-section at an interface end, such as interface end 143 and interface end 145.

The elliptical cross-section includes a major axis indicated by length A and a minor axis indicated by length B, measured within the cross-section plane. A difference between the major axis and the minor axis is indicated by length C. In general, oblique cut angle θ, length A, and length B are related through Equation 1, below:

B=A*Cosine(θ) (Equation 1)

Given two of the three parameters A, B, and θ, the third parameter may be computed according to Equation 1. For example, given a desired oblique cut angle θ and a length A, length B may be calculated using Equation 1. A resulting cut plane 120 along the oblique cut angle θ will have a diameter of A. Cut plane 120 should be made at the oblique cut angle θ (e.g. cut angle 490) along the dimension of the minor axis. Furthermore, only oblique cut angles are applicable in the context of embodiments of the present invention and therefore each cut angle is referred to herein as an oblique cut angle. In one exemplary embodiment, an oblique cut angle θ of thirty degrees defines the cut angle of cut plane 120. In such an embodiment, the major axis has length A=24, the minor axis has length B≈20.784610 (i.e. 24*Cosine(30 degrees)), and C is approximately equal to 1.61 (i.e. A-B). Length A, length B, and length C may be measured in arbitrary but consistent units. In such an embodiment, elevation angle 136 may range between zero and sixty degrees. If a different range for elevation angle 136 is required for a particular design, then a corresponding different cut angle may be specified along with corresponding values for length A and length B.

FIG. 5B illustrates a perpendicular view of cut plane 120, in accordance with one embodiment. As shown, cut plane 120 has equivalent orthogonal dimensions D and E measured within cut plane 120. Continuing the example of FIG. 5A, dimensions D and E are equivalent and correspond to length A. In alternative embodiments, cut plane 120 may not conform to a circle and dimensions D and E may not be equivalent.

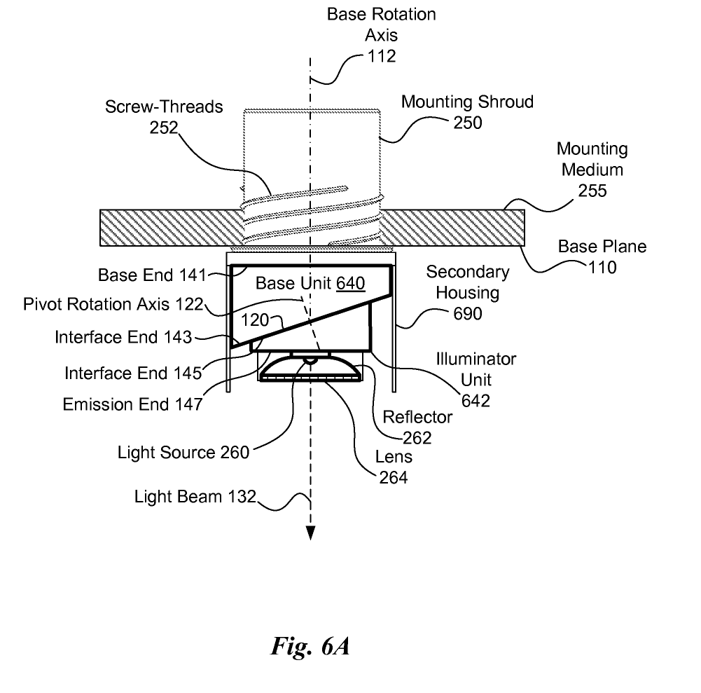

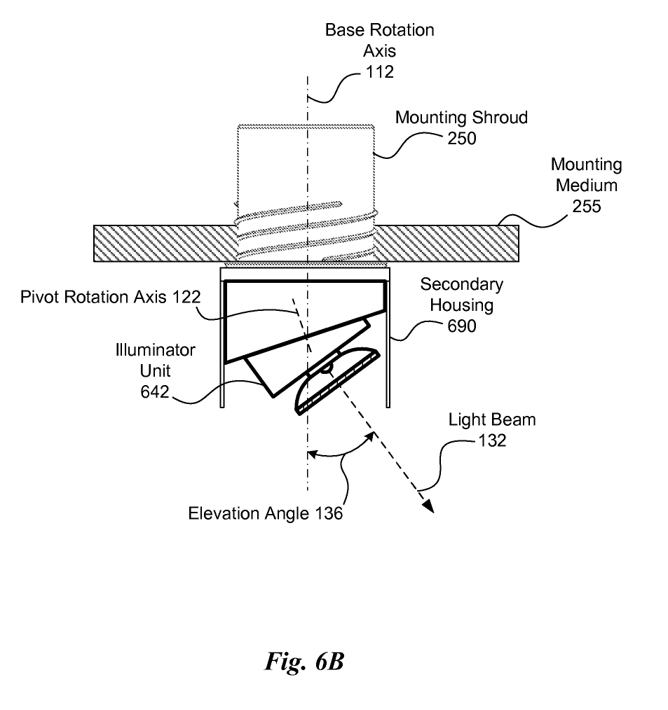

FIG. 6A illustrates a luminaire that includes a secondary housing 690, in accordance with one embodiment. The luminaire comprises a base unit 640 corresponding to the base element described previously and an illuminator unit 642 corresponding to the illuminator element described previously. As shown, base unit 640 includes base end 141 and interface end 143. Base end 141 is fabricated to be substantially parallel with base plane 110. Base unit 640 is rotationally coupled to mounting shroud 250, and configured to rotate about base rotation axis 112. Interface end 143 is fabricated to be substantially parallel to cut plane 120. Illuminator unit 642 includes interface end 145 and emission end 147. Illuminator unit 642 also includes a light source 260, and may include a reflector 262 and lens 264. Illuminator unit 642 is rotationally coupled to base unit 640 and configured to rotate about pivot rotation axis 122. Light source 260 may be thermally coupled to a heat sink (not shown). The heat sink may be recessed within mounting shroud 250.

In one embodiment, secondary housing 690 is configured to circumferentially encompass base unit 640 and illuminator unit 642. Secondary housing 690 may be fabricated from clear, translucent, or opaque material, including reflective material. The material may be neutral in color, or may impart color (e.g. red, yellow, green, etc.). Secondary housing 690 may be fabricated to include a circular, elliptical, rectangular, or other cross-section. Secondary housing 690 may include a cross-section that varies along a geometric centerline.

FIG. 6B illustrates the luminaire of FIG. 6A comprising illuminator unit 642 pivoted within secondary housing 690, in accordance with one embodiment. As shown, light beam 132 is directed according to elevation angle 136 and a rotational position about base rotation axis 112. In certain embodiments, a maximum value for elevation angle 136 may position light beam 132 to intersect secondary housing 690.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A luminaire comprising:
a cylindrical base element comprising a base end and an opposing first interface end, wherein the base end is substantially parallel to a base plane, and wherein the first interface end is substantially parallel to a cut plane inclined at an oblique cut angle relative to the base plane;
a first rotary joint coupled to the cylindrical base element, the first rotary joint configured to enable the cylindrical base element to rotate about a base rotation axis, wherein the base rotation axis is normal to the base plane;
a cylindrical illuminator element comprising a second interface end and an opposing emission end, wherein the second interface end is substantially parallel to the cut plane; and
a second rotary joint coupled to the cylindrical illuminator element and the cylindrical base element, the second rotary joint configured to enable the cylindrical illuminator element to pivot about a pivot rotation axis, wherein the pivot rotation axis is normal to the cut plane,
wherein the cylindrical illuminator element further comprises a light source configured to generate a light beam for transmission through the emission end, and wherein a direction for the light beam is determined according to a rotational position of the cylindrical base element about the base rotation axis and a rotational position of the cylindrical illuminator element about the pivot rotation axis.

2. The luminaire of claim 1, further comprising a base mate coupled to the first rotary joint.

3. The luminaire of claim 2, further comprising a mounting shroud configured to be removably coupled to the base mate.

4. The luminaire of claim 3, wherein the mounting shroud includes screw-threads configured to be screwed into a mounting medium.

5. The luminaire of claim 4, wherein the mounting medium comprises a ceiling panel or a wall panel.

6. The luminaire of claim 1, wherein the first rotary joint is coupled to a cable, and the cable is coupled to a ceiling mount or a wall mount.

7. The luminaire of claim 6, wherein the cable comprises electrical wires configured to provide an electrical path for transmitting electrical energy from the ceiling mount or the wall mount to the light source.

8. The luminaire of claim 1, wherein the first rotary joint is coupled to a rod, and the rod is coupled to a ceiling mount or a wall mount.

9. The luminaire of claim 8, wherein the rod comprises electrical wires configured to provide an electrical path for transmitting electrical energy from the ceiling mount or the wall mount to the light source.

10. The luminaire of claim 1, wherein the cylindrical illuminator element comprises a heat sink housing coupled to an optics housing.

11. The luminaire of claim 10, wherein the light source is thermally coupled to a heat sink comprising the heat sink housing.

12. The luminaire of claim 10, wherein the light source is disposed within the optics housing

13. The luminaire of claim 1, wherein the cylindrical illuminator element further comprises:
a reflector; and
a lens, wherein the reflector is configured to reflect light from the light source to the lens, and
wherein the lens is configured to form the light beam from at least the reflected light generated by the light source.

14. The luminaire of claim 13, wherein the reflector includes a reflective coating.

15. The luminaire of claim 13, wherein the lens includes at least one optical coating layer.

16. The luminaire of claim 1, wherein the light source comprises a light-emitting diode (LED) assembly that includes at least one LED chip.

17. The luminaire of claim 16, wherein the light source further comprises a spectral conversion element comprising at least one phosphor compound for converting light energy from the at least one LED chip to longer wavelengths.

18. The luminaire of claim 1, further comprising a secondary housing configured to circumferentially encompass the cylindrical base element and the cylindrical illuminator element.

19. The luminaire of claim 1, further comprising a converter system for converting electrical energy delivered by power mains to a voltage signal for driving the light source.

20. The luminaire of claim 19, wherein the voltage signal is transmitted from the cylindrical base element to the light source through at least two rotary electrical contacts.
